(19) United States
(12) Patent Application Publication
(10) Pub. No.: US 2018/0247359 A1
(43) Pub. Date: Aug. 30, 2018

(54) GIFTING SYSTEM

(71) Applicant: Joyce Kressler, Worcester, MA (US)

(72) Inventor: Joyce Kressler, Worcester, MA (US)

(21) Appl. No.: 15/966,471

(22) Filed: Apr. 30, 2018

Related U.S. Application Data
(63) Continuation-in-part of application No. 15/165,872, filed on May 26, 2016.
Application No. 15/165,872 is a continuation of application No. 13/907,844, filed on May 31, 2013, now Pat. No. 9,373,139.
Application No. 13/907,844 is a continuation of application No. 11/863,694, filed on Sep. 28, 2007, now Pat. No. 8,478,661.
Application No. 11/863,694 is a continuation-in-part of application No. 11/778,465, filed on Jul. 16, 2007, now abandoned.
Application No. 11/778,465 is a continuation-in-part of application No. 11/777,915, filed on Jul. 13, 2007, now abandoned.
(60) Provisional application No. 60/807,415, filed on Jul. 14, 2006.

(51) Int. Cl. G06Q 30/06; G07F 17/40; G06Q 20/40; G06Q 20/04; G06Q 20/28; G06Q 20/12; G06Q 20/38

(52) U.S. Cl. CPC G06Q 30/0621; G07F 17/40; G06Q 30/06; G06Q 20/387; G06Q 20/0453; G06Q 20/28; G06Q 20/12; G06Q 20/4014

(57) ABSTRACT

A system for purchasing and delivering a specific gift, in which, at the time of the purchase, the buyer, instead of being provided with the gift, is provided with a gift proxy or special package which includes a gift token which includes an authentication device. The gift proxy can also include a picture of the specific gift. The buyer delivers the gift proxy to the recipient. At a future time and place, not necessarily pre-determined, the recipient provides the gift proxy to the seller, the seller authenticates the gift proxy, and the recipient receives the gift from the seller. A centralized and networked order management system monitors the gift tokens. The system can be online and/or store oriented, and can be used to transact in goods and/or services other than gifts.

### CROSS-REFERENCE TO RELATED APPLICATIONS

This application claims the benefit under 35 U.S.C. § 119(e) of U.S. Provisional Application No. 60/807,415, filed Jul. 14, 2006, which is hereby incorporated by reference.

This application is a continuation-in-part/divisional of U.S. patent application Ser. No. 15/165,872 filed May 26, 2016, which is a continuation of U.S. patent application Ser. No. 13/907,844 filed May 31, 2013, granted as U.S. Pat. No. 9,373,139, which is a continuation of U.S. patent application Ser. No. 11/863,694 filed Sep. 28, 2007, granted as U.S. Pat. No. 8,478,661, which is continuation-in-part of U.S. patent application Ser. No. 11/778,465 filed on Jul. 16, 2007, which is continuation-in-part of U.S. patent application Ser. No. 11/777,915 filed on Jul. 13, 2007, and claims any and all benefits as provided by law including benefits provided under 35 U.S.C. § 120 of the prior filed applications and the contents of each of the earlier filed applications are hereby incorporated by reference in its entirety.

### FIELD OF THE INVENTION

This invention involves a system for purchasing and delivering goods and services.

### BACKGROUND OF THE INVENTION

This invention is directed to a sales and business process and a gifting system. The system and process is not limited to gifts and can support any sales transaction that requires location shift and/or time delay.

Embodiments of the invention address a significant problem. In what has become a very mobile society, people frequently live or work apart from family members, friends and loved ones. While bridal/baby showers, engagement parties, weddings, graduations, and other significant occasions marked by gift-giving occur in one city, often those with whom these experiences are shared reside in another. This necessitates either transporting gifts from one location to another, mailing them, exchanging/returning them or storing them—all of which are inconvenient in varying degrees. Additionally, large or cumbersome gifts pose problems for transport whether being given locally or at a distance.

The traditional sales process involves two parties: a buyer and a seller involved in a two-phase transaction: order and fulfillment. This applies to in-store sales as well as catalog and on-line shopping. In-store sales connect the two steps and fulfillment happens immediately after payment, while on-line and catalog buyers wait for a few days for delivery. Sometimes fulfillment is delayed because of inventory issues, need for customization, or other reasons, but in general, sellers start fulfillment as soon as the order is placed and try to complete it with minimum or no delay.

The following are characteristics of the current process as represented by FIG. 1:
1. The transaction involves two sides: a buyer and a seller.
2. All the required information for order and fulfillment is collected from the buyer at the time of order.
3. Fulfillment starts immediately after the order is placed; it is performed by the seller, and should be completed as soon as possible.

The current process works well most of the time, but with some limitations. One of those limitations occurs when the desired time and place for delivery are unknown or assumed incorrectly, or a product is back-ordered, or an item is too large to transport by an individual (e.g., the buyer).

For example, in the case of wedding gifts, many couples might prefer to delay the delivery of gifts and presents until after the wedding and the honeymoon; especially if the wedding ceremony is not taking place in the area where they plan to live.

As another example, in home renovation and remodeling, many home improvement projects fall behind schedule. One may want to order new kitchen appliances in advance but keep the delivery time open until the kitchen is ready.

These and other difficulties experienced with the prior art devices have been obviated in a novel manner by various embodiments of the present invention.

It is, therefore, an outstanding object of some embodiments of the present invention to provide a gifting system that significantly reduces the logistical burdens of providing gifts to remote recipients or for those who would prefer to delay receipt of a gift.

Another object of some embodiments of this invention is to provide a gifting system that maintains all of the psychological benefits of conventional gifting procedures.

A further object of some embodiments of the present invention is to provide a gifting system that expands the variety of gifts that can be practically considered in connection with a particular gift-giving situation.

It is another object of some embodiments of the invention to provide a gifting system that simplifies and eases the retailers inventory challenges.

It is a further object of some embodiments of the invention to provide a gifting system that simplifies and reduces the security oriented delays and inconveniences associated with transportation.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a system for purchasing and delivering a specific gift or other purchase, in which, at the time of the purchase, the buyer, instead of being provided with the gift, is provided with a gift proxy or special package which includes a gift token which includes an authentication device or token enabling the buyer or the bearer of the gift proxy to redeem the gift proxy for the gift it represents (e.g., associated with the token). The gift proxy is designed to look like an attractively packaged gift with the exterior bearing the brand identity of the seller (e.g., any retail/wholesale store or vendor including online stores and vendors) and includes a picture of the specific gift selected by the buyer. The buyer delivers or sends the gift proxy to the recipient. The recipient provides the gift proxy to the seller, the seller authenticates the gift proxy and the token and the recipient receives the gift from the seller. An order management system can be used to monitor the gift tokens and keep track of the redemption of each gift proxy.

### BRIEF DESCRIPTION OF THE DRAWINGS

The character of the invention, however, may best be understood by reference to one of its structural forms, as illustrated by the accompanying drawings, in which:

FIG. 1 is a diagrammatic representation of the prior art conventional process for purchasing products and gifts.

FIG. 2 is a diagrammatic representation of the first step in a purchase process embodying the principles of the present invention,

FIG. 3 is a diagrammatic representation of the second step in a purchase process embodying the principles of the present invention,

FIG. 4 is a diagrammatic representation of the third step in a purchase process embodying the principles of the present invention,

FIG. 5 is a diagrammatic representation of the fourth step in a purchase process embodying the principles of the present invention,

FIG. 6 is a diagrammatic representation showing all four steps in a purchase process embodying the principles of the present invention,

FIG. 7 is a diagram showing the initial form of the card stock used to form a first gift proxy embodying the principles of the present invention,

FIG. 8 is a diagram showing the first step in forming the first gift proxy from the card stock shown in FIG. 7,

FIG. 9 is a diagram showing the second step in forming the first gift proxy from the card stock shown in FIG. 7,

FIG. 10 is a diagram showing the third step in forming the first version of the first gift proxy from the card stock shown in FIG. 7,

FIG. 11 is a diagram showing the third step in forming the second version of the first gift proxy from the card stock shown in FIG. 7,

FIG. 12 is a diagram showing the fourth step in forming the first version of the first gift proxy from the card stock shown in FIG. 7,

FIG. 13 is a diagram showing the fourth step in forming the second version of the first gift proxy from the card stock shown in FIG. 7,

FIG. 14 is a perspective view of the closed configuration of the first version, as shown in FIG. 12, of the first gift proxy from the card stock shown in FIG. 7,

FIG. 15 is a perspective view of the open configuration of the first version, as shown in FIG. 12 in FIG. 14, of the first gift proxy from the card stock shown in FIG. 7,

FIG. 16 is a diagram of the closed configuration of a second gift proxy embodying the principles of the present invention,

FIG. 17 is a diagram of side view of the gift proxy shown in FIG. 16,

FIG. 18 is a diagram of the open configuration of the second gift proxy, and

FIG. 19 is a diagram of the side view open configuration of the second gift proxy shown in FIG. 18.

FIG. 20 is a diagram of a system according to some embodiments of the invention.

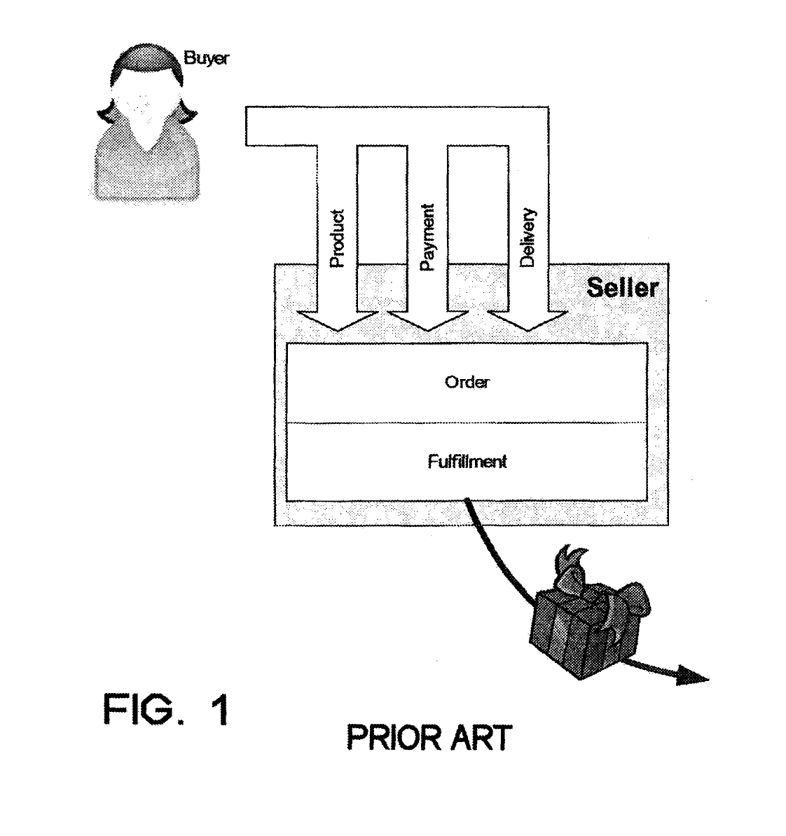

### DETAILED DESCRIPTION OF THE INVENTION

One object of this invention is to eliminate the inconvenience of transporting gifts or other purchases through the use of a gifting system that generates preferably, a high quality image of the chosen gift within a box, card or other packaging form, thus allowing the purchaser to actually select a specific item (for instance, one on a registry) and present—or mail—its facsimile or gift proxy at or in time for the required occasion. Upon opening, the gift of choice is revealed in miniature. In its simplest form, this is a variation of a redeemable store credit, except that it maintains the character and benefits of a specifically chosen gift, as opposed to the impersonal nature of a generic redeemable store credit. The gift proxy is better than a gift card because it provides the appeal and thoughtfulness of receiving a real gift.

The activation of this gifting system can involve the generation of a miniature (and more transportable) facsimile of a product/gift along with pertinent details of purchase, purchaser, and redemption procedure contained within a box or box-like form, alternate packet, package or envelope construction. No matter what the actual size of the item purchased is, the gift proxy contents would contain a miniaturized representation (size to be determined but, for example, hand-held in scale). There are unlimited variations for the construction, presentation and shape of the gift proxies, and they can be in 2- or 3-dimensional formats such as round/cylindrical, triangular/pyramid, square/cube, rectangular or any invented forms that can either mimic existing identity of a specific store or merchandiser or used to create a new branding opportunity. All versions preferably contain a high quality reproduction of the product or service to be purchased, in a form that the seller, product vendor, gifting system or buyer wishes to use, including but not limited to a presentation quality photograph, a hologram or a 3-D image. Materials for the gifting system include but are not limited to paper, card stock, plastic, plastic-coated paper or other flexible sources.

Examples of gifting systems according to embodiments of the invention include the following types. First: A 2-dimensional printable version easily assembled into a 3-dimensional construction so that all elements are self-contained in one-piece construction. When the lid is lifted or the envelope unfolds, the image and all other pertinent information appear as part of the construction. The interior contains a gift image, redemption and tracking information; the exterior takes on the characteristics and/or graphic design of the seller from which it is generated.

Second: A 2-piece construction with the first part pre-printed with essential generic information for each purchase such as seller and/or product vendor branding, tracking information and redemption policy; the second part would be exclusively for the gift segment to be inserted/assembled at the time of purchase containing product information, inventory control data, bar-coding or other tracking method (such as RFID or NFC).

Third: A decorative tamper-proof card with a photo or graphic image of the item and all pertinent information generated at point of purchase or at the cashier that can be inserted into a small box or envelope. (This card can be larger, perhaps similar to a postcard, and could replace the generic gift cards that are presently available at most retailers.)

Fourth: A separate box that, once assembled, has the reduced image of the produce/gift and information inserted separately, attached by a self-adhering removable back, tape or similar material. This actual image can be set either flush with box or can have an adhesive element or some other construction that permits the item to stand away from the back of the box and appear 3-dimensional. A holographic image can be produced for similar effect.

Fifth: Similar elements could be used in a version of a “pop-up” card.

Sixth: In addition to physical on-site retail locations, the gift system could also be accessed via the web, for example directly through retailers or through sites such as the weddingchannel.com (central online site linking major participating retailers like Tiffany's®, Bloomingdale's®, Crate & Barrel®, Williams Sonoma®, etc. and all consumers who have registered with those retailers). The gift proxy ordered online can be sent to either the giftee (e.g., the intended recipient of the gift) or the giftor (e.g., the party giving the gift).

Seventh: Ultimately, the gift or item could be available via home access to be purchased directly, online printed, and assembled at the purchaser's site.

In any preferred embodiment of the invention, each complete unit can be self-contained with information concerning the purchase within the gift proxy and token including: First, the system according to the invention can provide a high quality image of item (photo, hologram, other). The specific image can be selected by the product manufacture, seller, the gift proxy system, the purchaser of the gift proxy or any combination thereof. Second, the system according to the invention can provide a written description and/or stock number or other identification which can tie the gift proxy to a product in the seller's stock management system. Third, the system according to the invention can provide information about redemption and credit policy. Fourth, the system according to the invention can provide information about the availability of product, i.e. store, internet, etc. Fifth, the system according to the invention can provide an area for gift message to recipient. Sixth, the system provides an encrypted coding or number system to track the purchase transaction and prevent counterfeiting and theft. Seventh, the system according to the invention can provide information linking the purchase to the seller's internal inventory management system. Eighth, the system according to the invention can provide the seller with the ability to skew (e.g., variance monitoring) for store performance. All embodiments can be tailored to reflect seller brand and/or logo.

Seller Advantages of the preferred embodiment of the invention: First, the system saves TIME and MONEY. Second, the system provides a consumer-friendly experience. Third, the system identifies seller outlet where purchased—branding. Fourth, the system assists with inventory management. Fifth, the system captures purchaser information. Sixth, the system reduces costs of packing materials. Seventh, the system reduces additional freight/mailing costs. Eighth, the system eliminates time/labor for packing/gift wrapping. Ninth, the system reduces time/labor/costs for returns of actual items. Tenth, the system reduces time/labor/costs for re- crating of second-round purchase. Eleventh, the system reduces time and preparation costs for shipping of larger, heavier products. Twelfth, the system eliminates re-stocking of returns. Thirteenth, the system eliminates risk of damage in transit. Fourteenth, the system provides new opportunity for branding and marketing. Fifteenth, the system allows the time-saving and expense-saving measures reduce overhead costs. Sixteenth, the system overcomes risk of loss of sale if a specific registered gift is out of stock. Seventeenth, the system offers expanded opportunity for sales of larger gifts, such as furniture, because it eliminates transport issues to site of celebration or event.

Purchaser Advantages of the preferred embodiment of the invention: First, the system allows a user-friendly purchase. Second, the system provides a lightweight alternative, compared to heavy gift (e.g., Kitchenaid® mixer). Third, the system provides easy “gift” transport during travel, less cumbersome and unbreakable. Fourth, the system is able to provide personalized gift selection instead of generic credit. Fifth, the system provides visibility of gift when opening (the “Ah-h-h effect”). Sixth, the system provides additional savings recognized in less dollars spent for mailing charges as compared with cost for mailing actual (heavier) gift and insurance for same. Seventh, the system, if the token is mailed, reduces the risk of wrong or broken present being received. Eighth, the system makes it less likely that the token will be lost or misplaced as compared to gift cards. Ninth, the system is ideal for “destination wedding” gifts. Tenth, the system simplifies the giving of larger, more costly group gifts and transport of same to a party or event. Eleventh, the gifting system if more personalized than a generic gift card.

Recipient Advantages of the preferred embodiment of the invention: First, the system avoids transport issues and potential breakage or loss. Second, the system eliminates need for physical returns (schlep” factor or returns). Third, the system allows the transactions to be completed at a seller location of choice and allows the recipient to redeem the gift proxy at his/her convenience. Fourth, the system connects a specific gift to specific giver. Fifth, the system is as versatile as a generic credit but more personal and has more cache. Sixth, the system records gift value/purchaser in the event of loss or misplacement. Seventh, the system avoids inconvenience of shipped gift arriving and no one at home to receive it (gift system can fit in mailbox). Eighth, the system eliminates “schlep factor” at the actual wedding, shower, or other gift-giving occasion.

Advantage for all parties of the preferred embodiment of the invention: Most gift-givers have a pre-set specific amount that they are prepared to spend. In choosing a gift, the cost for mailing a gift is often deducted from this total. With the new gift system alternative, no deduction for shipping costs is necessary which is a benefit for all parties concerned. The full amount can be applied which means that more money actually goes to the seller and the recipient gets the benefit of a more expensive gift. Furthermore, reduction in usage of packaging materials is an environmental advantage as well.

Technical issues: The preferred embodiment of this invention would provide an anti- theft activation system which would prevent unauthorized duplication, counterfeiting, and theft of the tokens. Each token would carry an identification information device that carried token identification information. The token identification device might be a printed image (e.g., a barcode or 2D barcode), a computer chip, a radio frequency identification device (RFID), a near-field communication (NFC) memory chip, a magnetic imprint or other similar information storage technology. The anti-theft system would include a method for interrogating the token to read that token identification information. The anti-theft system would also include information storage in the order management system for keeping track of the activities in connection with a particular token. The seller's order tracking system can be used to track the order based on the order identification information and enable the seller to void or disable the order should the gift proxy be lost or stolen and transfer the order information to a new order number and issue replacement gift proxy to the buyer or a designated other person (e.g., the giftor or the giftee).

The preferred embodiment of this invention would also include a tracking device connected through a network to a centralized data collection and processing system to protect and monitor the activity of individual tokens with auditing capabilities to establish compensation amounts in connection with licensing agreements. Although this tracking device system could be different from the above described anti-theft activation system, it could also employ the same infrastructure and simply employ specialized programming in the order management system so that all of the necessary royalty calculation information could be captured and maintained within the order management system.

The proposed sales/gifting system according to some embodiments of the invention changes and improves the current sales process by allowing a buyer to place an order without the fulfillment information—enabling delayed fulfillment. The missing information is provided by a receiver at a future time. The receiver may be the buyer or any third party that is authorized by the buyer to complete the transaction.

The new sales system achieves new functionality by introducing the following changes to the current sales process. The system defines “Order” and “Fulfillment” as sequential, but separated processes. The system allows “Orders” with incomplete “Fulfillment” information. The system introduces a “Receiver” as a third party involved in the sales process. The system allows the Receiver to determine the time and place of delivery and provides it as an input to the fulfillment process. The system introduces a secure and safe mechanism to transfer control of the order from a buyer to a receiver. The system allows the Seller to be able to recognize and confirm both a buyer and a receiver of an order.

Definitions. In alphabetical order. Buyer is an individual that is ready to buy from a seller. The buyer determines what to buy and is responsible for payment. A buyer may be representing a business or an organization.

Delivery is the process of transferring the goods or services from the seller to the receiver. Delivery may be in hand at the time of order, store pickup, via shipping service, or electronically for digitized content like movies, music, etc.

Fulfillment is the second step in a sales process. It involves the information a buyer provides at the time of order and information from the receiver about where and when goods and/or services are delivered.

Order is the first step in a sales process. It involves information exchange between the seller and the buyer about the item(s) sold and payment.

Order Confirmation is a confirmation that an order was placed and paid for. It includes information needed in order to activate the fulfillment process.

Order Control Token is an object in the form of a card, picture, email message, a letter, or any other format that allows the buyer to transfer the control of the order to a receiver.

Payment is any method, cash, check, money order, credit card, electronic fund transfer, or any other legal method, used by the buyer and the seller to provide consideration for the sale.

Receiver is an individual or an organization that is authorized by a buyer to receive the purchased goods and/or services. The receiver determines when and where goods and/or services are delivered. A buyer may decide to take delivery of goods and/or services. In this case, he or she is both the buyer and the receiver.

Seller is a business, store, organization, web site, or individual that is offering goods or services for sale.

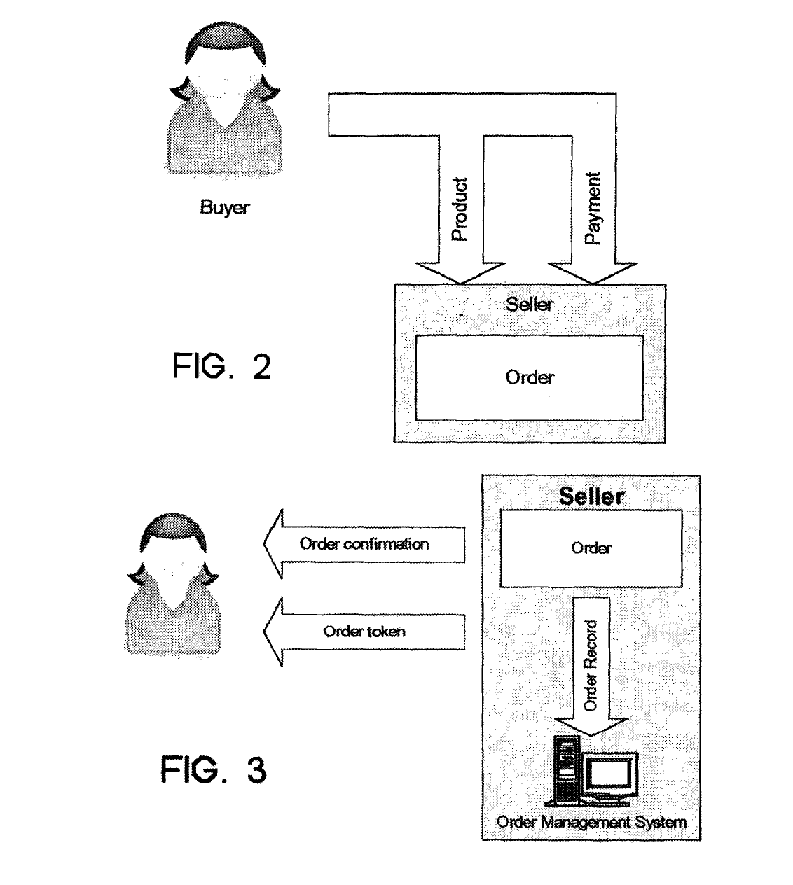

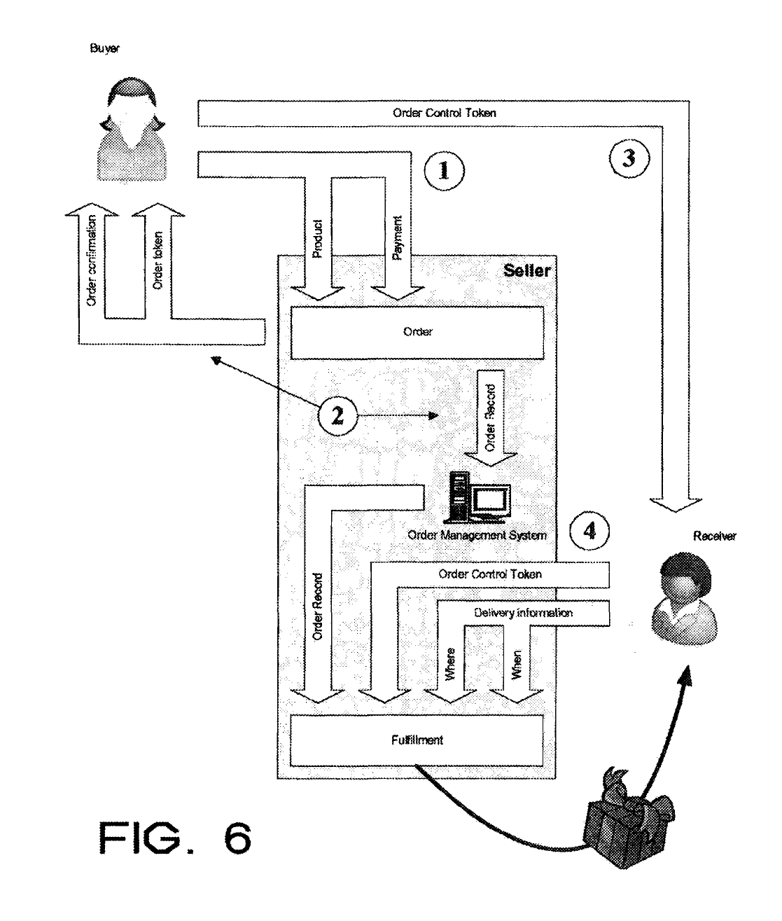

Process description: The following section describes the process of the new sales system as represented in FIGS. 2 through 5 and summarized in FIG. 6. This general process description applies to in store sale as well as on-line and other forms of sales transactions when goods and services are purchased. The process involves 4 major steps.

Step 1—Order placement: as represented in FIG. 2, a buyer places an order with the seller. The order includes the variety and quantity of items ordered as well as shipping, gift wrap, customization, state and local tax and any other information the seller needs to process the order.

Step 2—Order Processing: as represented in FIG. 3, the seller processes the order. It involves accepting and approving payment, updates of inventory and financial records, creating records in the order management system for future processing, and generating a receipt and a control token for the buyer. The control token represents a device which gives the buyer the right and power to redeem the token for the purchased item in the future. In the preferred embodiment of this invention, the token would be part of a gift proxy designed to convey the psychological elements of the specific gift selected by the buyer. However, the gift proxy can be compact and easily transported.

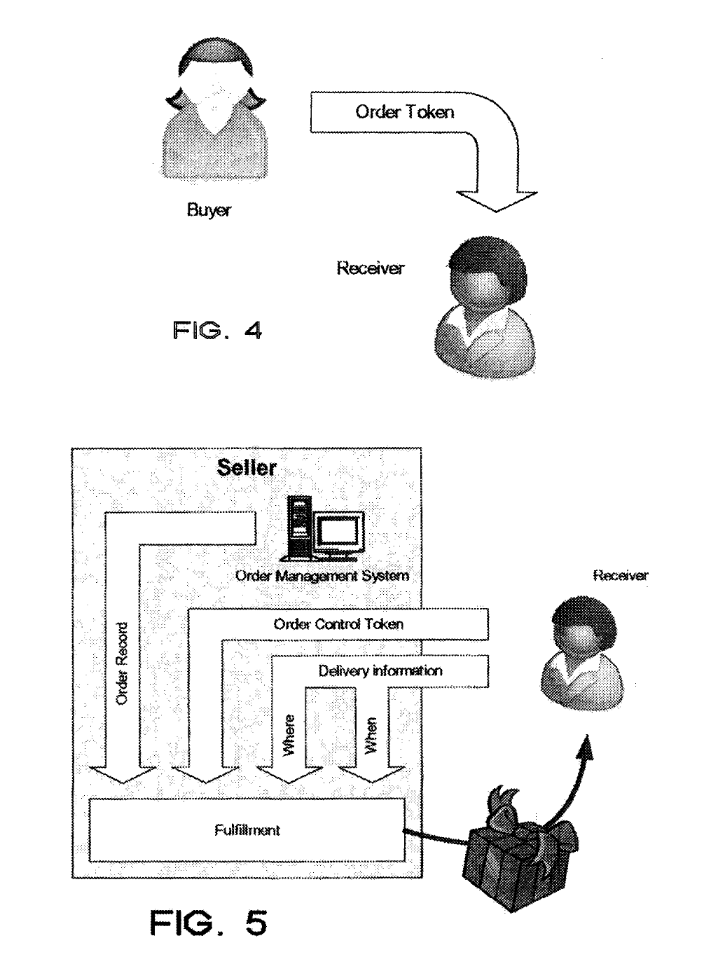

Step 3—Transfer of token: as represented in FIG. 4, this step is optional and happens only if the buyer decides to authorize a third party, as a gift recipient, to be the receiver of the order. This can be in the form of a card, email, text message, etc. In the preferred embodiment of this invention, the gift proxy, including the token, would be conveyed to the gift recipient, either personally or by other means. In the preferred embodiment, the gift proxy, including the token would be presented to the gift recipient at a ceremony or similar gathering. In the alternative, the gift proxy can be mailed or sent to the recipient.

Step 4—Fulfillment Processing: As Represented in FIG. 5, fulfillment starts when the receiver or the holder of the “order token” initiates it. The seller uses input from the receiver as well as information stored in the order management system. Delivery may be a store pickup, shipping of goods, execution of a service, or electronic transfer of digitized content. Within the preferred embodiment of this invention in the order management system would be a national or international network of computers adapted to monitor the flow and processing of the tokens, to gather information about the tokens and assure the genuineness of the tokens. For example, the tokens could include holographic encrypted identification coding that could be very difficult, if not impossible to reproduce, and would assure the genuineness of the token.

Full process view: as represented in FIG. 6, this diagram shows the flow of information between a buyer, a seller, and a receiver from the time an order is placed until goods are delivered.

Applications: The new sales process is not replacing the traditional sales process. For those people who still prefer to go to a store to buy a gift, this new process expands their options. However, the new sales process also provides an excellent solution that helps all parties (buyer, seller, and receiver) save time and money by being able to transact the purchase online.

Gifts: a gift is paid for by one person and received by another. Many times the act of giving is part of a ceremony associated with a special event like a birthday, baby shower, wedding, holiday, or other special occasions. However, the time and place of celebration may not always be the most convenient for gift giving (or receiving). The new sales process preserves the ceremonial aspect of gift giving by allowing the packaging and delivery of the “order control token” in an appropriate format that enables the recognition (and appreciation) of the gift while allowing the recipient of the gift to choose when and where the gift is delivered.

Wedding Registry: The new sales process allows recipients to delay the delivery of gifts, an important service for couples who celebrate with friends and family away from home.

Corporate gifts: A company may select a holiday gift to reward for employees and let them pick-up the gift at the local store, avoiding the cost of distribution and shipping.

Relocation: Redeem at the local store nearest final living destination.

Price Protection: Gift system value equals exact amount incurred by purchaser and can either be redeemed for specific gift or used in place of a gift card of equal value.

Customization issues: Like many other innovations, the new sales system can be customized to address the specific needs of the marketplace. The following terms and conditions are subject to variation and can be determined on a system- wide basis or can be determined at the discretion of individual sellers.

Sales tax: Sales tax is paid locally, based on place of delivery. In the preferred embodiment, the order management system would keep track of the sales tax associated with the delivery and charge the buyer for that tax.

Inventory issues: What happens when a seller is out of stock when the receiver asks for delivery? In that case, the preferred embodiment would allow the receiver to delay a fulfillment until the item is available or to select an alternative product of equal value or use the gift proxy as stored credit.

Discontinued items: What happens when a seller is out of stock and can no longer order the item from the supplier? In that case, the preferred embodiment would allow the receiver to select an alternative product of equal value or use the gift proxy as stored credit.

Fulfillment cost: What happens if buyer did not pay for shipping but the receiver wants the item delivered? In the preferred embodiment, the buyer would have the choice at the time of purchase of authorizing charging for shipping at the time of fulfillment or not. If the buyer authorizes the shipping charge, and the buyer will be charged at time of fulfillment. In that case, if there is no shipping charge, and the buyer will not be charged. If the buyer does not authorize charging for shipment, and then the receiver will be required to pay for shipping.

Time limit: For how long can a receiver wait before taking delivery? In the preferred embodiment, there might be time limits for redemption of specific gift item at which time the amount would convert to a store credit of equal amount.

Returns/Exchange: Who gets the credit? In the preferred embodiment, the receiver can return the token for store credit to be applied to items of recipient's choice of equal value.

Transfer: Can a gift be re-gifted? Sold to others? In the preferred embodiment, the token may or may not be transferable to another receiver at the discretion of the seller.

Unclaimed items: How to process unclaimed items? In the preferred embodiment, the receiver needs to redeem the token within a window of time set forth by the seller or laws governing a specific state.

Lost Token: How to handle claims for a lost “control token”? In the preferred embodiment, the order management control system will keep track of tokens and will allow a lost token to be replaced and the original token to be canceled.

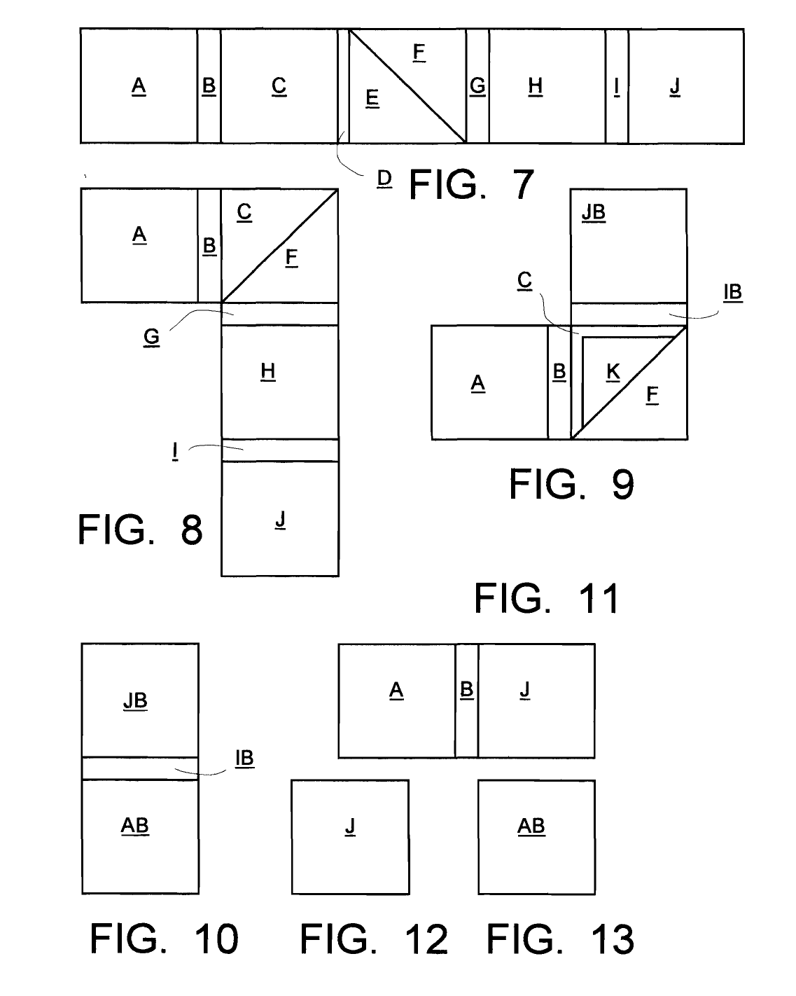

One embodiment of the gift proxy and token element is shown in FIGS. 7-15. FIG. 7 shows an elongated piece of card stock divided into sections by fold lines. Each section is designated by an underlined numeral and the back of each section is designated by the corresponding underlined numeral followed by an underline to B.

FIG. 8 shows the card stock folded over at the fold lines between Section C and Section D, and between Section D and Section E, and a fold over between Section E and Section F, to form the back and front of a pocket between Section C and the hidden Section E (behind Section F).

FIG. 9 shows the result of folding on fold lines between Section F and Section G, and between Section G and section H, to form the bottom of the pocket between sections C and hidden section E. In this way, the backside section D3 and Section JB are exposed forward. FIG. 8 shows a card K inserted into the pocket.

FIG. 10 shows one way that the gift proxy can be completed. In this first version, starting with FIG. 9, folds are made between Section A and Section B and between Section B and Section C, so that section is folded over the remainder of the card thereby exposing the backside section AB.

In this first version, FIG. 12 shows the final result of section JB being folded at the fold line between Section JB and Section IB, and between Section D3 be and HB, so that Section JB folds down over the rest of the gift proxy, thereby exposing Section J forward. Section J. might bear an image of gift wrapping and ribbons or such accessories may be added to make the gift proxy look like a wrapped gift. In the preferred embodiment, this example of a final package would be three to 8 inches on a side and an eighth to ¾″ in thickness. Package design and dimensions are subject to the discretion of the seller.

In a second version shown in FIG. 11, starting from FIG. 9, Section JB is folded down over the rest of the card thereby exposing section J forward.

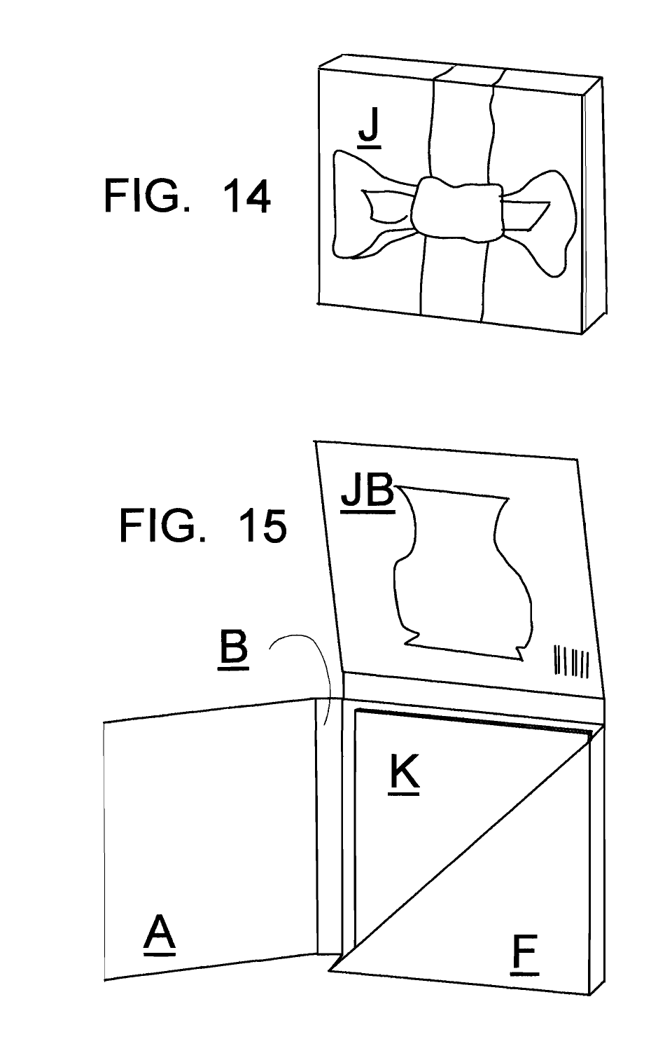

Then, in FIG. 13, Section A is folded over the rest of the card thereby exposing the backside Section AB. Section a might include graphics and promotional information concerning the seller from which the gift and the gift proxy was purchased.

FIG. 14 shows a decorated version of the gift proxy that would result from exposing section J forward, in the final step, as shown in FIG. 12, as it might be presented as a gift proxy, with the gift package graphics exposed.

FIG. 15 shows an open structure for the gift proxy presented in FIG. 9, suitable for display on a gift table or for review by event guests. In this case, the surface JB is exposed with a picture of the gift (shown as a vase) and the token (shown as a bar code) that confirms the authenticity of the gift proxy. The card K is carried in the pocket and includes instructions for redeeming the gift or other information or images. Section A might carry text or images. In the process of opening up the gift proxy, Section A would be exposed and might carry such information as the store from which the gift proxy was purchased. Section F might also carry that information.

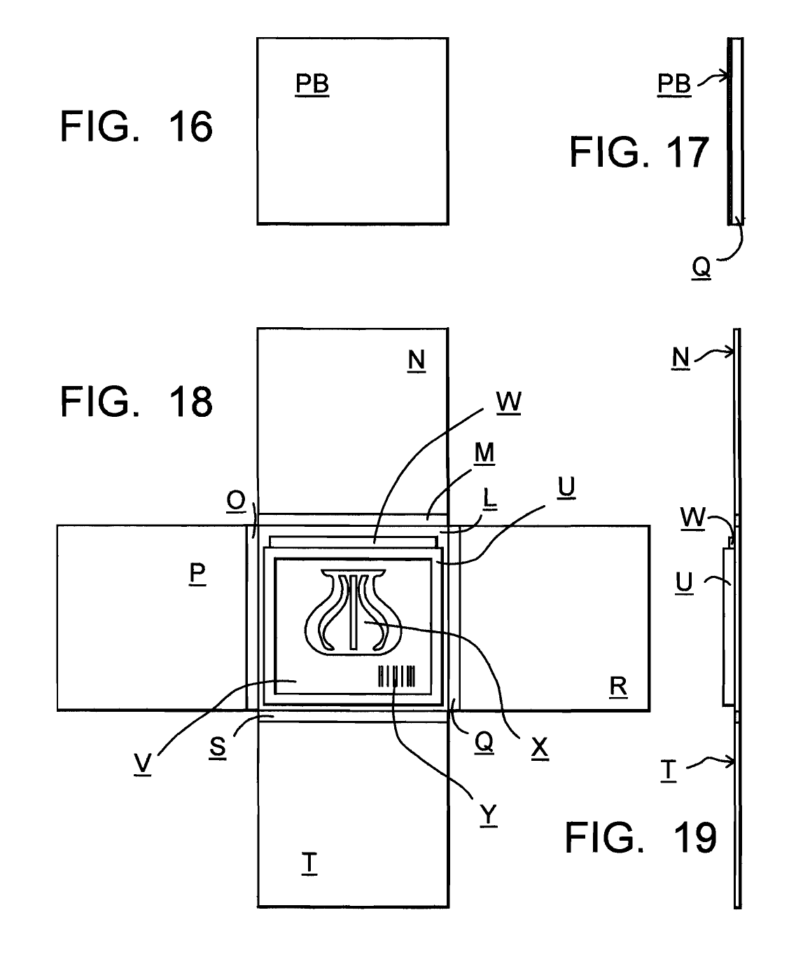

Another version of the gift proxy is shown in Figures 16 through 19. As Shown in FIG. 18, in this embodiment, a cross-shaped card stock is divided by bend lines into a series of sections designated by an underlined letter, namely a central Section L, and four outwardly-extending arms forming sections M and N, Sections O and P, Sections Q and R, and Sections S and T. The rear side of each of the sections is designated by its corresponding underlined letter followed by an underlined B.

As further shown in FIG. 18, attached to the front of Section L is a pocket U having a large opening at the top, and a large forward facing window V that exposes the inside of the pocket U and its contents. Inside the pocket U is a card W that bears an image of the gift X and the token Y which confirms the authenticity of the gift proxy.

FIG. 19 shows a side view of the embodiment shown in as a Front Elevation View in FIG. 18. This view shows the pocket U mounted on the card stock, and shows the card W extending from the pocket U.

FIG. 16 shows the embodiment shown in FIG. 18, but with the arms folded over upon one another to cover and enclose the pocket U and the card W. Section PB is exposed forward and would normally carry gift wrapping graphics or the name of the store from which the gift proxy was purchased.

FIG. 17 shows a side view of the arrangement shown in FIG. 16. It is important to note the three dimensional character created by the folding over of the Sections M, O, Q, and S. Section Q is shown in FIG. 17.

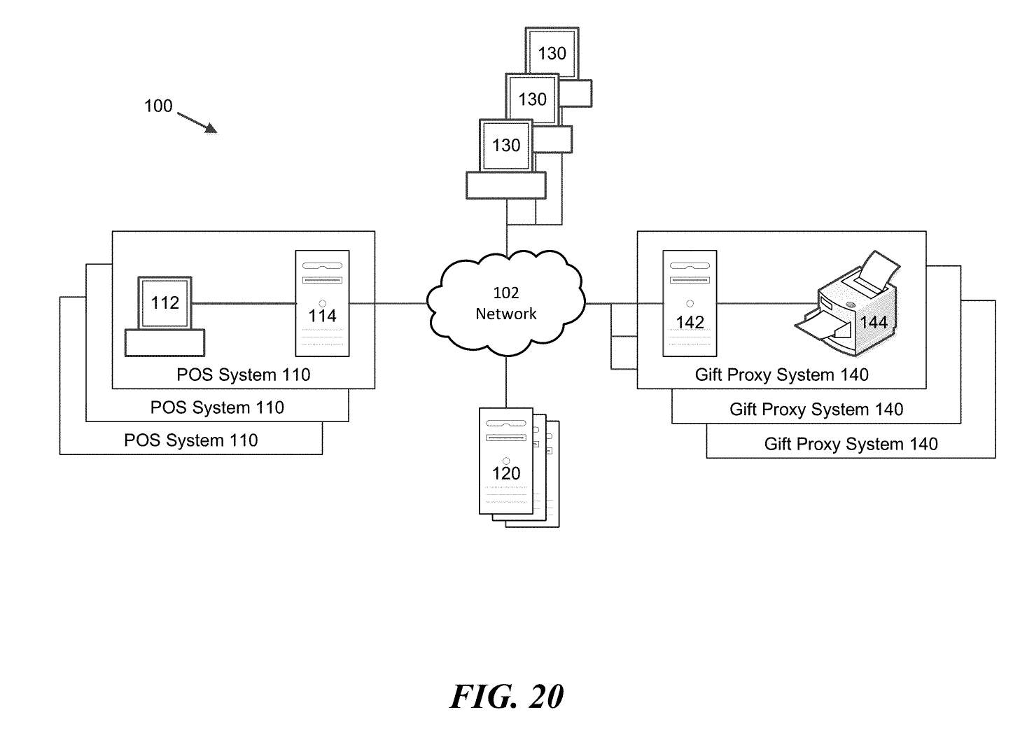

FIG. 20 shows a diagrammatic view of a system 100 according to some embodiments of the invention. The system 100 can include a Point of Sale (POS) system 110 that is connected by a network 102 (e.g., the internet) to a Gift Proxy System 140. The POS system 110 can include a POS terminal 112 (e.g., a cash register or similar terminal) that enables a store employee to enter an order for at least one product or service into the POS system 110. The POS system can receive and store the order information (e.g., order identifier, purchased product information, buyer information, date, and price) that enables the order for the at least one product or service to be tracked and processed. The order information can include an information element that indicates that the order includes a gift proxy or is for delayed fulfillment. The POS terminal 112 can be connected to one or more POS computers 114 that support the POS system 110 for a given location (e.g., a store or warehouse). The POS computer 114 can be connected by a network 102 to other POS systems (not shown) and/or a central computer system 120 for the seller, for example, a system that tracks orders and inventory. In accordance with some embodiments of the invention, the POS system 110 can send or transmit the order information for a gift proxy purchase to the central computer system 120 and the central computer system 120 can receive and store the order information for each gift proxy purchase. The central computer system can then send or transmit a gift proxy instruction to the gift proxy system 140. In accordance with some embodiments, the central computer system 120 can include a web server that enables users to place orders using a remote computer 130 that is connected to the network 102 (e.g. the internet). The computer 130 can be any computerized device (e.g., a desktop computer, a laptop computer, a smart phone or a tablet) capable of running a web browser or dedicated client application that can communicate with the web server of computer 120 enabling the user to place an order for a product or service.

The Gift Proxy System 140 can include a gift proxy computer 142 connected to the network 102 to receive gift proxy based orders. The gift proxy computer 142 can be programmed to receive gift proxy based orders and generate the gift proxy item (e.g., FIGS. 8-19), for example, using a gift proxy generating system 144. In accordance with some embodiments of the invention, the gift proxy generating system 144 can include a high quality (e.g., photo quality) printer and/or a 3-D printing system. In accordance with some embodiments of the invention, the Gift Proxy System 140 can be located remotely from the POS system 110, for example, in a different physical location or time zone, a different city, state or country. In accordance with some embodiments of the invention, the gift proxy item can be placed in shipping container such as an envelope or box and delivered either by hand or by a public (e.g., USPS) or private (e.g. FEDEX, UPS, etc.) delivery service to the buyer, the giftor, the giftee, or a third party.

In accordance with some embodiments of the invention, the Gift Proxy System 140 can receive gift proxy orders from many different POS systems 110 (e.g., from many different sellers). In accordance with some embodiments of the invention, the Gift Proxy System 140 can receive gift proxy orders from one or more central computer systems 120 (e.g., from many different sellers). For example, the Gift Proxy System 140 can receive gift proxy orders from two TARGET™ stores in different location (e.g., Boston and Los Angeles) as well as from AMAZON.COM™ and WAYFARE.COM™. In accordance with some embodiments of the system, the Gift Proxy System 140 can be a single location that receives all gift proxy orders and delivers the gift proxy items to the intended recipients using public and private delivery services. In accordance with some embodiments of the invention, the Gift Proxy system 140 can include a plurality of subsystems distributed all over the country or the world and configured to route gift proxy orders to a gift proxy subsystem that is in close proximity to the intended destination. In accordance with some embodiments of the invention, a central gift proxy computer 142 can receive each gift proxy order and based on the delivery location of the gift proxy order, route the gift proxy order to a close gift proxy subsystem. Each local gift proxy subsystem can include a gift proxy computer 142 and a gift proxy generating system 144.

Each of the computers 114, 120, 130, and 142 can include one or more processors (CPUs or cores) and associated memory (e.g., volatile and non-volatile memory) and be configured to store and execute an operating system (e.g., Linux, Unix, Mac OS, Windows) and/or programs that complete one or more elements of the gift proxy process. Computer 130 can be embodied in a desktop computer, a laptop computer, a tablet, a smart phone or dedicated kiosk. POS terminal 112 can also be a computer as described herein. The computers 114, 120, 130 and 142 can be connected to the network 102 using a wired or wireless network connection (e.g., Ethernet, 3G, 4G, 4G LTE, 5G, and/or WiFi). Computer 114 can be connected to POS terminal 112 by a wired or wireless network connection. Computer 142 can be connected to gift proxy generating system 144 by a wired or wireless network connection.

In accordance with some embodiments, the POS system 110 can include product and service information about some or all the products and services that are offered for sale at that location or by that seller. The information can be stored in a POS database that is connected to the POS computer 114 and configured to provide some or all of the information to the POS terminal 112. The POS database can be centrally located at a seller central computer system or distributed over multiple computer systems and in some embodiments, the content of the POS database can vary by region. The product and service information includes all the information that the seller needs to place, process and fulfill the order and can include all the information the Gift Proxy System 140 needs to generate the Gift Proxy Item. The product and service information can include a product or service identifier (e.g., a stock keeping unit or SKU number) that can be used to identify the product or service to be sold. The product and service information can also include other information, such as, the number of units in stock and the location of each unit, the manufacture's name and product model or part number, the price or unit cost of the item, and any other information that may be useful for the sale of the product or service (e.g., color information, size information, user information to be provided by buyer or recipient). After an order is placed, the order information can be stored in the same or a different database connected to the POS computer 114. Each order record in the database can include the product or service identifier or SKU, the number of units purchased, the purchase price per unit, the date of purchase, the number of Gift Proxy items to be created, and any other order information needed to track and fulfill the order.

In accordance with some embodiments of the present invention, the product and service information stored in the POS database can include an image to be associated with the product or service that can be used to generate the gift proxy item. The image can include a digital image that can be used to render a high quality photographic image (e.g., a jpeg, png, or tiff digital image) of the product or service, and/or can include 3-D printable file (e.g., an OBJ, STL, CAD, PLY, X3DB, X3D, VRML formatted file). In accordance with some embodiments of the invention, each product or service identified in the POS database can be associated with one or more images (e.g., high resolution—640×480 or greater, depending on the picture size, medium resolution—320×240 or greater, depending on the picture size) that can be used to generate a gift proxy item for the product or service. In accordance with some embodiments of the invention, the POS system can include a gift proxy image database or a connection to a gift proxy image database such that the buyer can select the image to be used to generate the gift proxy item at the time the order is placed. The images that appear in the database can be pre-selected by the product manufacture or service provider, the seller, the gift proxy service or any combination thereof. In these embodiments, when the order is placed, the POS terminal can be used to display to the buyer a set of high quality images of the product, images to be associated with the product or service, or images of 3 dimensional objects that are replicas of the product or 3 dimensional objects (e.g., tokens) to be associated with the service.

In operation, the buyer can browse through a store or a catalog and approach the POS station in a store or a fulfillment warehouse and inform the sales person that they wish to place an order. Alternatively, the buyer could use the internet on their personal device (e.g., a personal computer, tablet, or smartphone) or a public kiosk to connect to the web server associated with the store or fulfillment warehouse and place the order. In either event, the POS system 110 will receive and process the order for the product or service. When the order is created and received, the order will identify the specific product or products (e.g., by SKU or item number(s), quantity, including any color and size identifiers of each item). For services, the order can include an identifier associated with the specific service as well as any other information needed (e.g., location, address, color, scope of work, size and/or shape) to describe and perform the service. In accordance with some embodiments of the invention, the buyer will also specify that a gift proxy item is to be produced and delivered to a location specified by the buyer and the order information will also indicate that order provides for delayed fulfillment and thus, the gift proxy item will be used to redeem the product or service at a later time. The gift proxy item can be shipped, for example, to the buyer's home or place of work or to a third party address such as a giftor's or giftee's home or place of work or a location where the buyer/giftor/giftee can pick up the gift proxy item at a later time.

In accordance with some embodiments of the invention, after the order is placed, the order is received and processed by the POS system 110. Where the order information includes a field or element that indicates that a gift proxy has been ordered or that the order provides for delayed fulfillment, the POS system 110 will send or transmit gift proxy instruction to the gift proxy system 140. The gift proxy information can be communicated in encrypted form or using encrypted communications to protect the information. The gift proxy instruction can include a description of the item (e.g., products or services) along with a product or service identifier (e.g., a product number or SKU), a quantity sold, an order identifier, and an authentication device or token. The authentication device or token can include a unique number, symbol or other identifier, that can be used to authenticate the order from the seller that sold the product or service to the buyer. In accordance with some embodiments of the invention, the authentication device or token can include a digital certificate that enables the gift proxy system to confirm that the gift proxy information has not been changed. In accordance with some embodiment, the gift proxy instruction can include an identification of a high resolution representation feature of the gift proxy, such as high resolution image or a 3-D printer compatible file. The gift proxy instruction can include high resolution representation data including in the instruction or a pointer (e.g., a file location, a URL or other indicator) of where the data file is stored. In accordance with some embodiments, the gift proxy instruction can include a field or other identifier that indicates a type of gift proxy (e.g., a high resolution photograph, a hologram, a 3-D printed object, or other device).

After receiving the gift proxy instruction, the gift proxy system evaluates the type field or the high resolution representation data in the gift proxy instruction to determine what type of gift proxy has been ordered. For example, if the type indicates a photograph or the high resolution representation is an image file, the gift proxy system will configure itself to prepare a high resolution photograph based gift proxy and if the type indicates a 3-D printed object or the high resolution representation is a 3-D object file, the gift proxy system will configure itself to prepare a 3-D printed object. For example, in accordance with some embodiments, the gift proxy system can connect to a high resolution printer to print the image and produce a photograph that forms part of the gift proxy. The printer can also print the gift proxy box or enclosure (e.g., FIGS. 8-19) to further customize the gift proxy. In accordance with other embodiments, the gift proxy system can connect to robots of a fulfillment system that coordinate the selection and retrieval of predefined elements that make up the gift proxy. In this embodiment, the high quality images or 3D printed or molded replicas of the product can be selected from storage bin in the warehouse, just like a real product and presented to a person or another robotic system that assembles and optionally, packages the gift proxy.

In accordance with some embodiments of the invention, the gift proxy system can be configured to produce a gift proxy item having a standardized or default size and shape as well as packaging (e.g., the envelope or box size). In accordance with some embodiments of the invention, the gift proxy instruction can include additional fields that indicate the size and shape of the gift proxy item and the gift proxy system can produce a gift proxy item customized according to the size and shape specified by the buyer and/or vendor.

After the gift proxy item is printed or fabricated, the gift proxy can be packaged and stored for pick-up or delivered to the specified recipient. The recipient (or giftee) can take the gift proxy item to the store or location (e.g., a fulfillment warehouse) indicated on the gift proxy or the packaging to receive the product or to arrange for the provision of the services. The sales person can scan or otherwise enter the information from the gift proxy into the order system to determine if the gift proxy item information matches the information in the ordering system. If the information matches an order held by the system, the sales person can check their stock and allow the recipient to obtain the product or arrange to receive the service. In accordance with some embodiments of the Alternatively, the recipient can exchange the product or service for a different product or service or arrange to receive money or store credit instead of the product or service.

The benefits of various embodiments of the present invention can be summarized as follows.

The invention provides convenience of transport for destination wedding gift- giving. Eliminates issues of potential breakage, loss, cumbersome traveling with something heavy or large. Imagine having to take a gift through pre-flight security and dealing with possibility of it not fitting in x-ray screening, having to unwrap a gift to show what it is or even being deemed threatening so that it is confiscated!

The invention provides likewise, same convenience noted for traditional out-of-town weddings, showers, parties, etc.

The invention provides for usage in all categories—baby showers, engagements, weddings, house warming, Christmas or other holiday gifts—indicating versatility of idea.

Additional advantage at local weddings when storage is an issue (small condo or need to be left at parents' home). With Gift System, recipient can get the gift later where and when they want it!

The invention provides also re local weddings, eliminates need to transport gifts at the end of the affair when everyone is trying to leave. Issues of loss, breakage, not enough car transport space cited.

The invention provides for a specific gift to be selected by recipient. Connects giver to a specific gift as well.

The invention provides at the time of registering, couples can also check off if they would like to receive the gift via Gift System in addition to or as an alternative to a gift card.

The invention provides “wow” factor when presented.

The invention provides giving a gift in this format that is more secure than a gift card if automatic registration of gift and giver occurs at purchase allowing for ease to be traced if lost or stolen or even misplaced.

The invention provides redemption based on actual amount spent, just like an actual gift (including applicable local taxes) so that full amount would be realized even if redeemed for another item (vs. gift card funds which would need to be applied to taxes or would be an out-of-pocket added expense).

The invention provides for adding the savings of shipping to the purchase price, potentially resulting in a more costly gift being given.

The invention provides an option to cover shipping instead of going to the store to pick up.

The invention eliminates problems of gifts needing to be re-delivered when no one is home.

The invention provides an effective alternative when an item is out of stock or needs to be special ordered.

The invention provides that a gift in this format gives the recipient the flexibility to change her mind.

The invention provides recognition for branding opportunities and for tailoring for specific occasions via additional miniature charms (similar to wooden scoop that Williams Sonoma® includes in store wrapping).

The invention provides all information is conveniently self-contained in one place, i.e. “gift”, donor, redemption info, personal note, etc.

The invention provides convenience for large group gifts (crib or furniture as an example).

The invention provides suggested usage for corporate and holiday gift giving.

The invention provides consistently reinforced aspects of the Gift System: ease/convenience.

The invention provides nice presentation.

The invention provides versatility.

The invention provides personalization.

The invention also provides a very important benefit in the case of gifts which are very large, bulky, or difficult to transport. It might be inconceivable for a gift giver to travel to a gift-giving event with a bedroom set including large pieces of furniture or a complete set of dishes or crystal. With the benefit of the present invention, the gift giver could travel to the event with the gift proxies for very large gifts and present the gift proxies in a simple and convenient manner. A variation on this benefit could be that a group of people could get together and purchase significantly larger item or parts of larger gifts. Each could transport and present a gift proxy for the specific piece that that giver elected to give.

The value of this “big item” benefit is provided to all parties involved in the transaction. The gift giver is thereby allowed to choose from a much broader universe of potential gifts, such as large furniture, appliances, or structures such as kitchen cabinets, sporting goods, or power tools, many of which might be perceived as much more desirable gifts than the typical easily-transportable kinds of gifts. The vendor is able to offer the gift giver a whole new universe of potential gifts which might be much more exciting and have much larger profit margins and profits than the typical easily transportable kinds of gifts, so the defender can actually make more money and create a more favorable customer experience. Finally, the gift recipient might find the kinds of gifts presented in this new universe of potential gifts to be much more appropriate, practical, and valued then many of the typical easily-transportable kinds of gifts that are currently often chosen by logistical considerations.

NON-LIMITING EXAMPLE—THE OLD WAY: Melissa grew up in Massachusetts, Mike was a California boy. After meeting in graduate school in Miami, Coconut Grove, Fla. was to become their new place of residence once they were married.

Melissa's maid of honor, attending law school in Chicago, planned the first bridal shower there. This worked out well because a large group of the bride's friends came from the Midwest where she attended college as well as Mike's grandmother, sister, and some aunts and cousins. The wedding was to take place in the bride's hometown of Worcester, Mass. where family and friends planned a second shower.

Mike and Melissa registered at all the popular retail stores: Crate & Barrel®, Williams Sonoma®, Tiffany's®, Bloomingdale's®, and Pottery Barn®. Their list was extensive and covered everything from furniture and small appliances to dishes and cookware.

The boxes were piled high after the Chicago shower. Melissa's mom was given the task to haul them back to Worcester and temporarily store them in her home. This was not an easy or enjoyable task, especially traveling alone by airplane back to Massachusetts. Fortunately, none of the items were lost, broken or stolen in transit. The pile was even higher after the Worcester party, but a least the presents were being moved to a nearby location.

Then came the wedding. Gifts poured in from all over the country: Kitchenaid® mixer from Aunt Jane in L.A., a full set of dishes from Midwest sorority sisters, professional pots and pans from Aunt Rae in Sarasota, on and on, all delivered to the bride's parent's home in Worcester where the wedding was to take place. No gifts were being sent to Coconut Grove as the newlyweds were in the process of buying a home, and there was no storage room in their tiny apartment.

After their beautiful wedding, Mike and Melissa headed off to the Greek Isles for their honeymoon. Obviously, they had no intention of taking their gifts with them since they were not going directly back to Florida. Mom declared that she would go bankrupt if she had to pay for shipping the 100+ presents. Melissa said, “No problem. While we are on our honeymoon, you and dad can return all of the gifts. Since all the stores where they were purchased also have locations in our area, we will re-purchase all the same gifts with credits from the exchanges.”

Mom and dad spent hours and hours repacking the presents, loading the car (multiple times!), driving to all the separate store locations, waiting for price checks, and finally receiving thousands of dollars of credits for the merchandise returned. There's got to be a better way . . . and there is.

Mike's best friend from college, Trevor, lives in Salt Lake City. He was really looking forward to coming to his buddy's wedding and wanted to buy a beautiful gift for the occasion. He went directly to Crate & Barrel® where he knew the happy couple had registered.

After a salesperson escorted him to the registry computer (a fixture in every retail store across the country), he keyed in their names and the day of their wedding and voila! up came their selections complete with pictures and prices. Wow, he couldn't take his eyes off the bright red Italian cappuccino maker and decided it was the perfect gift. But after finding out that it weighed 35 pounds, it no longer seemed like a good idea when he thought of having to lug it along with all the other things he needed for the trip.

THE NEW WAY: When he expressed his concern to the salesperson she said, “No problem. Get them a Gift Proxy instead.”

With that, she took his credit card (with his permission) entered his selection and within 3 minutes out came what appeared to be a glossy card-stock sheet imprinted with a gorgeous full-color image of the cappuccino machine, serial numbers, UPC code, redemption information and an area on which to write a personal message each in distinct segments. After Trevor wrote his good wishes in the space provided, the salesperson neatly made folds along the edges to encapsulate the gift information and so that the reverse side, bearing the distinctive Crate & Barrel® font, became the exterior of the container.

It was amazing—the slender hand-held package had the distinctive look of a Crate & Barrel® gift box. Before she sealed it, she showed him how the bride and groom would open the Gift Proxy and how his gift and message would appear. “This is fantastic,” he said. “They get exactly the gift that they want and I don't have to schlep it on two planes across the country.” As he slipped the trim package into his coat pocket he thought to himself, “Now I can even take my golf clubs.”

Trevor realized that he could use a Gift Proxy for the golf clubs he wanted to get his Dad in Florida for Father's Day. Trevor also realized that he could use a Gift Proxy for the canoe he wanted to give his brother when his brother graduates from the University of Colorado. End of example.

Another aspect of this invention involves an on-line shopping and gift system, and more specifically, a method to improve on-line shopping and gift giving.

This section describes how the new shopping and gift system works for eCommerce. The process is not limited to gifts and can support any sales transaction of goods and/or services that requires flexibility in delivery location and or time.

Introduction: The traditional sales process for both in-store and on-line involves a buyer and a seller that engage in a sales transaction. The transaction includes two phases: order and fulfillment. Buyers are involved in the first phase (order) while sellers have to complete the fulfillment phase. Sometimes fulfillment is delayed because of inventory issues, need for customization, or other reasons, but in general, sellers start fulfillment as soon as an order is placed and try to complete it with minimum or no delay.

This section describes a new method for on-line shopping of any product and for gift giving that allows customers to delay fulfillment and/or customize the fulfillment (not just the product) according to their needs.

Proposed system: The proposed on-line shopping and gift system changes and improves the current sales process by allowing a buyer to place an order without triggering the fulfillment phase. The decision about when to fulfill the order, how to fulfill it (shipping or pickup), and the delivery address (if needed) can be delayed, and therefore, no fulfillment information is required at the time of ordering. The missing information is provided in a future time by the buyer or a third party chosen by the buyer when they are ready to take delivery.

The new on-line shopping and gift system achieves new functionality by introducing the following changes to the current on-line shopping process. First, in some embodiments of the system, the system can be adapted to define “Order” and “Fulfillment” as sequential, but separated processes. Second, in some embodiments of the system, the system can be adapted to allow “Orders” with incomplete “Fulfillment” information. Third, in some embodiments of the system, the system can be adapted to introduce order deactivation and reactivation. Fourth, in some embodiments of the system, the system can be adapted to allow the buyer to determine the time and place of delivery and provide it as an input to the fulfillment process after placing the order. Fifth, in some embodiments of the system, the system can be adapted to introduce a secure and safe mechanism to transfer control of the order from a buyer to a receiver and to re-activate orders. Sixth, in some embodiments of the system, the system can be adapted so that the Seller would be able to authenticate a returning buyer (or a gift receiver) and reactivate an order. Seventh, in some embodiments of the system, the system is adapted to allow integration of on-line and in-store services.

On-line shopping and other eCommerce implementations: An on-line shopper collects items into a virtual shopping cart that he or she takes to checkout. During checkout, the eCommerce server lets the shopper customize items (example: adding gift wrap), calculates the total amount for the order, and collects billing and shipping information.

The new on-line shopping and gift system lets the shopper complete customization, provide billing information, and choose between “Complete now” and “Complete later” options during the checkout.

If a shopper selects “Complete now”, all shipping information (or store selection for “store pickup”) is required. However, if the shopper chooses “Complete later”, delivery method, shipping address, and other fulfillment information is not required at that time. Instead, the on-line shopping and gift system saves the order for future activation and starts a new process of order tracking and re-activation.

On-line order tracking and reactivation: Order tracking and re-activation works according to seller's policy. For example, if a seller decides an order must be completed within 60 days, the system will keep a record of order date, expiration date, and will send or transmit an alert before expiration.

The first action for the on-line order tracking and re-activation is to generate and share with the buyer a simple but secure method for re-activating the order. For example, the system assigns an order number and a password that will be used to activate the order. The information is presented to the buyer on the screen as “order confirmation” and it can be also delivered via email. Future activation of the order can be done by the buyer or by a third party the buyer authorizes to complete the order.

At the time of re-activation (by the buyer or a third party) all missing information must be provided so the seller can fulfill the order with no further delay.

The on-line order tracking and reactivation is unique to the on-line process. In-store shoppers get a gift representation (facsimile) that may include a unique code (with a bar code), a water mark, a hologram, and other security features that help sellers authenticate a gift at the time of redemption. For online shoppers the system must include digital security and authentication procedures that work even if the entire process is completed on-line and buyers (or gift receivers) never visit a store.

Enhancement to the on-line shopping and gift system: When this new on-line system is implemented to support gift giving or other transaction of goods and/or services, it can be enhanced in a number of different ways. For example, an embodiment of this system might be adapted so that a confirmation email to buyer may include a greeting card with the item(s) pictured and other graphics so the buyer can customize and print it. An embodiment of the system may be adapted so that a seller may email a gift message on behalf of the buyer with a customized graphics and/or animation that presents gift giving. An embodiment of this system might be adapted so that a seller can create a gift representation (facsimile) like the one given to in-store shoppers and send it to the buyer for delivery in person, or directly to the gift receiver. An embodiment of the system might be adapted so that order confirmation can be delivered to cell phones, PDA's and other capable devices. An embodiment of the system might be adapted so that stores may allow for integration of physical and virtual processes to match buyer's preferences. For example: An on-line shopper may select to pickup a gift facsimile at the local store. Another example: a receiver of a gift that was purchased on-line to be shipped may choose to complete the transaction in a store.

These examples are used to illustrate how a seller may customize the system to meet business needs. They don't represent all customization and enhancement options.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A system for producing a gift proxy comprising:
a point of sale (POS) system connected to a network, the POS system including a point of sale terminal and a POS computer, and being configured to receive and store information for orders for products and services;
a gift proxy system connected to the network, the gift proxy system including a gift proxy computer and a gift proxy generating device;
wherein after the POS system receives and stores order information for at least one product or service, the POS system transmits a gift proxy instruction to the gift proxy system and wherein the gift proxy instruction includes a high resolution representation associated with the at least one ordered product or service.

2. A system according to claim 1 further comprising:
a second point of sale (POS) system connected to a network, the POS system including a second point of sale terminal and a second POS computer and being configured to receive and store orders for products and services; and
wherein the second POS system transmits a gift proxy instruction to the gift proxy system and wherein the gift proxy instruction includes a high resolution representation associated with the at least one ordered product or service.

3. A system according to claim 1 wherein the high resolution representation associated with the at least one ordered product or service is a high resolution digital image and the gift proxy generating system uses the high resolution digital image to generate a high resolution photographic image that is used to construct the gift proxy.

4. A system according to claim 1 wherein the high resolution representation associated with the at least one ordered product or service is a 3-D printable file and the gift proxy generating system uses the 3-D printable file to generate a 3-D printed object that is used to construct the gift proxy.

5. A system for producing a gift proxy comprising:
a point of sale (POS) system connected to a network, the POS system including a point of sale terminal and a POS computer, and being configured to receive and store information for orders for products and services;
a gift proxy system connected to the network, the gift proxy system including a gift proxy computer and a gift proxy generating device;
wherein after the POS system receives and stores an order for at least one product or service, the POS system transmits a gift proxy instruction to the gift proxy system and wherein the gift proxy system retrieves a high resolution representation associated with the at least one ordered product or service from a gift proxy image database in response to receiving the gift proxy instruction.

6. A system according to claim 1 further comprising:
a second point of sale (POS) system connected to a network, the POS system including a second point of sale terminal and a second POS computer and being configured to receive and store orders for products and services; and
wherein the second POS system transmits a gift proxy instruction to the gift proxy system and wherein the gift proxy system retrieves a high resolution image associated with the at least one ordered product or service from a gift proxy image database in response to receiving the gift proxy instruction.

7. A system according to claim 1 wherein the high resolution representation associated with the at least one ordered product or service is a high resolution digital image and the gift proxy generating system uses the high resolution digital image to generate a high resolution photographic image that is used to construct the gift proxy.

8. A system according to claim 1 wherein the high resolution representation associated with the at least one ordered product or service is a 3-D printable file and the gift proxy generating system uses the 3-D printable file to generate a 3-D printed object that is used to construct the gift proxy.

9. A system according to claim 1, wherein the information for orders includes an information element that indicates that the order includes a gift proxy.

10. A system according to claim 1, wherein the information for orders includes an information element that indicates that the order is for delayed fulfillment

11. A system for producing a gift proxy comprising:
a point of sale (POS) system connected to a network, the POS system including a point of sale terminal and a POS computer, and being configured to receive and store information for orders for products and services;
a central computer system connected to the network, configured to receive and store information for products and services;
a gift proxy system connected to the network, the gift proxy system including a gift proxy computer and a gift proxy generating device;
wherein after the POS system receives and stores order information for at least one product or service, the POS system transmits the order information to the central computer, which receives and stores the order information, and subsequently the central computer system transmits a gift proxy instruction to the gift proxy system and wherein the gift proxy instruction includes a high resolution representation associated with the at least one ordered product or service.

12. A system according to claim 11 further comprising:
a second point of sale (POS) system connected to a network, the POS system including a second point of sale terminal and a second POS computer and being configured to receive and store information for orders for products and services; and
wherein after the second POS system receives and stores order information for at least one product or service, the second POS system transmits the order information to the central computer, which receives and stores the order information, and subsequently the central computer system transmits a gift proxy instruction to the gift proxy system and wherein the gift proxy instruction includes a high resolution representation associated with the at least one ordered product or service.

13. A system according to claim 11 wherein the high resolution representation associated with the at least one ordered product or service is a high resolution digital image and the gift proxy generating system uses the high resolution digital image to generate a high resolution photographic image that is used to construct the gift proxy.

14. A system according to claim 11 wherein the high resolution representation associated with the at least one ordered product or service is a 3-D printable file and the gift proxy generating system uses the 3-D printable file to generate a 3-D printed object that is used to construct the gift proxy

15. A system according to claim 11 further comprising:
a second point of sale (POS) system connected to a network, the POS system including a second point of sale terminal and a second POS computer and being configured to receive and store information for orders for products and services; and
wherein the second POS system transmits the order information to the central computer which receives and stores the order information, and subsequently the central computer system transmits a gift proxy instruction to the gift proxy system and wherein the gift proxy system retrieves a high resolution image associated with the at least one ordered product or service from a gift proxy image database in response to receiving the gift proxy instruction.

16. A system according to claim 11 wherein the high resolution representation associated with the at least one ordered product or service is a high resolution digital image and the gift proxy generating system uses the high resolution digital image to generate a high resolution photographic image that is used to construct the gift proxy.

17. A system according to claim 11 wherein the high resolution representation associated with the at least one ordered product or service is a 3-D printable file and the gift proxy generating system uses the 3-D printable file to generate a 3-D printed object that is used to construct the gift proxy.

18. A system according to claim 11, wherein the information for orders includes an information element that indicates that the order includes a gift proxy.

19. A system according to claim 11, wherein the information for orders includes an information element that indicates that the order is for delayed fulfillment.
